(19) United States
(12) Patent Application Publication
(10) Pub. No.: US 2017/0007082 A1
(43) Pub. Date: Jan. 12, 2017

(54) Waterless Composting Toilet

(71) Applicant: RONGBAO LI, Birmingham, AL (US)

(72) Inventor: RONGBAO LI, Birmingham, AL (US)

(21) Appl. No.: 14/797,109

(22) Filed: Jul. 11, 2015

(51) Int. Cl. A47K 11/03; C05F 3/04; A47K 17/00

(52) U.S. Cl. CPC A47K 11/03; A47K 17/00; C05F 3/04

(57) ABSTRACT

A waterless composting toilet comprises a seat, a solid waste transfer vessel, two waste containers for separating the liquid and the solid waste. The seat bowl has a liquid outlet in the front and a large opening in the back for solid waste transfer. The solid container has a venting system on the top, a humidity-providing liquid container at the bottom and a set of porous plates inside the container to create a multi-layer composting space. The transfer vessel is controlled manually through a mechanical assembly and serves either a waste receptor when the toilet is in use or a container lid after the waste is transferred into the container. The vessel is supplied with a bed of peat moss prior to use to keep the solid waste separating and spreading inside the container. The toilet provides sufficient aeration for waste decomposition without physically mixing of waste and is suitable for both private and public sanitation.

### FIELD OF THE INVENTION

The present invention relates to sanitary treatment of human waste, and more particularly relates to waterless composting toilet.

### BACKGROUND

Compositing toilets use the natural process of biological decomposition under aerobic conditions to treat and recycle human waste with no need of water flushing devices. Conditions required for microorganism growth and transformation of human waste to good fertilizer include sufficient aeration, proper temperature and moisture, and adequate nutrition supplies for microorganisms. Important considerations in developing compositing toilets include containment of infectious pathogens, reduction of offensive odors from human waste and adaptability to the user space. Modern compositing toilets involve different ways to mix the waste in a container for good aeration, leading to a complicated structure and costly manufacturing processes. These toilets usually combine the toilet bowl and waste container into a single unit, therefore, have an uncomfortable distance from the seat ring to the floor and a limited capacity.

The objective of this invention is to provide means to optimize the conditions for effective waste decomposition in a compositing toilet without waste mixing and to provide a cost appealing, environment friendly and expandable toilet system that can be used in private or public sanitation.

### SUMMARY OF INVENTION

The primary objective of this invention is to disclose a new design for a compositing toilet that provides optimal conditions for waste decomposition, adaptability for both private and public sanitation and recycling of human waste. The toilet comprises a seat, a solid waste transfer vessel, two waste containers for the liquid and solid waste, and a venting system attached to the solid container. The seat bowl has a liquid outlet in the front for urine and a large opening in the back for solid waste removal. Communication between the seat and the solid container is through transfer of the solid waste vessel. The vessel functions as a solid waste receptor or a solid container lid. Once the vessel is moved away from the solid container, the electrical fan in the venting system is turned on and withdraws the air from the seat and the solid container to keep unwanted odors away from the user space. When it is transferred to the solid container, the vessel delivers the solid waste to the container and closes up the container immediately. The large opening of the seat bowl directly faces the opening of solid container and can be on the bottom or on the side wall of the bowl, resulting in two different configurations of the compositing toilet in this invention.

When the toilet is in a side-by-side arrangement, the seat has an opening in its rear side, whereas the solid container has its opening in the front wall (Embodiment 1). In this configuration, the waste vessel transfers between the seat and the solid container through a rotating crank located between the seat and the container. When the toilet is in a stacking configuration, the seat opens on the bottom and the solid container opens on the top (Embodiment 2) with the vessel located inside the container. The vessel uses the concave surface to receive solid waste and the convex surface to close the container from the inside. The transfer of the vessel between the waste receptor and the container lid is performed by a mechanical assembly installed on the top of the container, including a handle with a spring, a trip lever and a stopper.

The solid container has a venting system on the top and an open liquid container at the bottom. The venting system includes a venting duct, an electrical fan at the bottom end of the duct and inside the container, and a natural power exhaust fan on the top of the duct. The water in the open liquid container provides humidity in the composting space. The composting space inside the solid container is separated into layers with a set of porous plates or screens. These screens are installed in an angle relative to the bottom on a set of retaining rods and are separated by a distance, allowing natural, proper waste packing and providing sufficient aeration for waste decomposition. The retaining rods can be moved up and down, therefore, allow the screen separators to move during the removal of the resulting compost or waste contents. The inlet air flows from the bottom, passes through the surface of the liquid and the layers of waste, and vents into a venting duct. When the vessel serves as the waste receptor, a bed of peat moss or sawdust can be laid in manually to keep the vessel clean. Such pre-laid peat moss serves as the medium for solid waste separating and spreading, as well as provides the carbon source for the microorganisms. Once the vessel is transferred to close up the solid container, the electrical fan is turned off; air circulation and ventilation occur naturally. The electrical fan can optionally remain in a lower operational level to keep positive aeration. A heating device can be optional for liquid or air, particularly necessary for the winter time or areas with extremely low temperature.

The above compositing container will remain undisturbed while maintaining optimal conditions for waste decomposition. With the said configurations and the ability to detach from the seat, the solid container can be readily transported and the resulting humus compost can be emptied. Since the size of the container is interchangeable, the toilet is suitable for both private and public use.

### BRIEF DESCRIPTION OF THE DRAWINGS

Two preferred embodiments of the invention will be described with reference to the following drawings.

FIG. 1. A side view of a side-by-side composting toilet in the open state in accordance with the invention.

FIG. 2. A side view of a side-by-side composting toilet in the closed state in accordance with the invention.

FIG. 3. A top view of the toilet seat and the waste vessel.

FIG. 4. A rear view of the toilet seat and the waste vessel.

FIG. 5. A solid waste container in the dumping orientation.

FIG. 6. A solid waste container in an expanded form.

FIG. 7. A side view of a stacking composting toilet in the open state in accordance with the invention.

FIG. 8. A side view of a stacking composting toilet in the closed state in accordance with the invention.

FIG. 9. Illustration of waste vessel transfer in a stacking toilet—as a container lid in the closed state

FIG. 10. Illustration of waste vessel transfer in a stacking toilet—turn over

FIG. 11. Illustration of waste vessel transfer in a stacking toilet—as a waste receptor in the open state.

FIG. 12. A top views of the waste vessel and the trip lever in the stacking toilet.

FIG. 13. A side views of the waste vessel and the trip lever in the stacking toilet.

### DETAILED DESCRIPTION OF THE INVENTION

In the following, the invention will be examined in greater detail with the help of two preferred exemplifying embodiments with reference to the attached drawings.

### Embodiment 1

### Compositing Toilet with a Side-by-Side Configuration

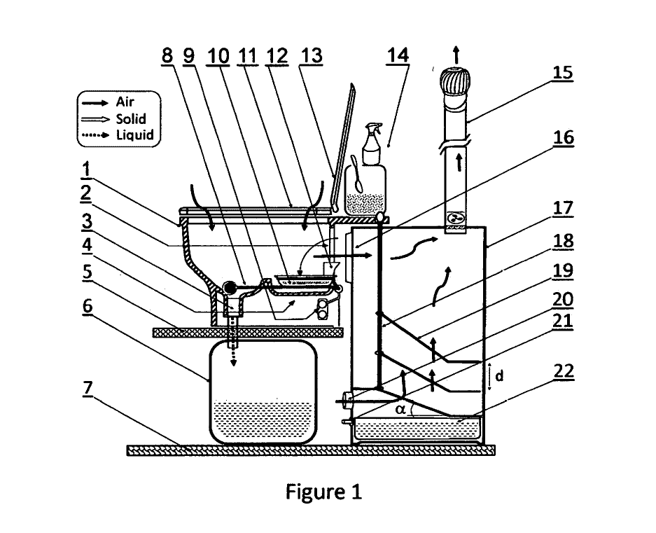

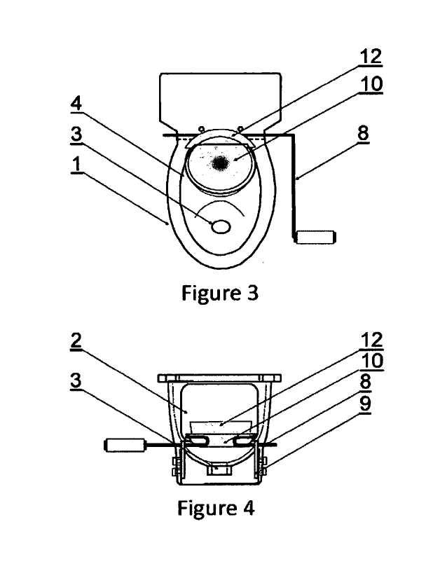

FIGS. 1-6 illustrate the toilet with a side-by-side configuration in accordance with the invention. The toilet comprises a seat 1, a solid waste vessel 10, a liquid container 6 and a solid container 17, with the seat and the solid container arranged side by side and their major openings, 2 (for the seat) and 16 (for the container) directly facing each other. In addition to the large opening 2, the seat has a liquid outlet 3 and a depression 4 on the bottom of the seat bowl. The outlet 3 leads to the liquid container 6 for collecting urine or cleaning water, the depression 4 accommodates the waste transfer vessel, and the large opening 2 allows the vessel to deliver the waste to and close up the solid container. The transfer of the vessel is carried out by a rotating crank 8 that is immobilized on the back of the seat by hinges 9. Attached to the top of the seat are the seat ring 11 and the seat cover 13. While the seat sits on the floor 5, both the liquid and solid waste containers stand on a lower ground level 7.

The solid container has an air inlet 20 and an open liquid pan 22 on its bottom with an overflow outlet 21 to keep the water from flooding inside the solid container. The container is equipped on the top with a venting system 15 consisting of a venting duct and two fans powered by electricity (inside) or natural wind power (outside). Both the air inlet 20 and the air outlet 15 are supplied with an air filter for each to prevent any dust escaping from the container. To enhance aeration of the waste piles, the inner container space is separated into layers by screens or thin porous plates 19. To allow natural, proper waste packing and dumping of the resulting compost, these screens are installed in an angle relative to the container bottom on a set of retaining rods 18 capable to move the screens up and down, with the angle (α) greater than 15° and the distance (d) between the screens greater than 3 inches, but less than 6 inches.

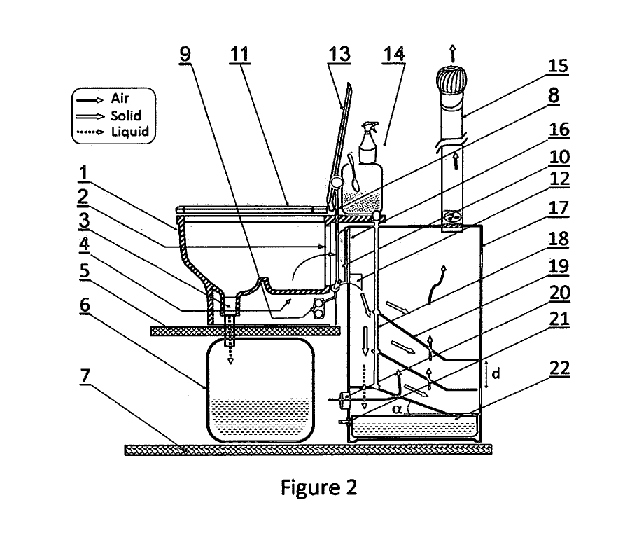

The vessel 10 stays closed to the solid container unless it is in use as the waste receptor. The vessel transfers into the seat bowl right above the depression 4 by moving the rotating crank handle down. At the same time, the electrical fan is turned on automatically and creates negative pressure in the space connecting the container 17 and the seat bowl 1, resulting in the removal of unwanted odors from the seat bowl, as illustrated in FIG. 1 and FIG. 2. The vessel has a guarding edge 12 in the opposite side to the crank connecting point to prevent solid waste from dropping outside the container. Once the vessel closes the solid container, the electrical fan is turned off or switched to a lower maintenance level. The air enters the container from the inlet 20 and passes through the liquid surface and the multiple layers of waste into the venting duct, as shown in FIG. 2. When the vessel is in use as the waste receptor, a bed of peat moss or sawdust 14 can be laid in manually to keep the vessel clean. These materials serves as the medium to keep the solid waste separating and spreading, and also provide the carbon source for the microorganisms. A small amount of water can be used to clean the vessel if it is necessary by using a hand pressure sprayer 14.

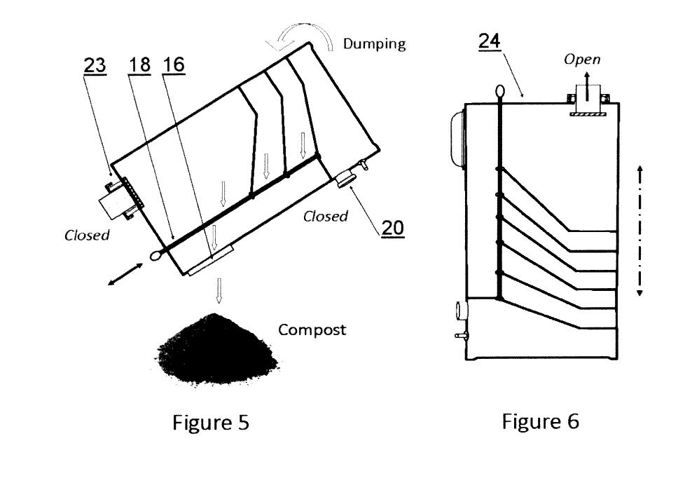

Once there is resistance to closing of the solid container, the container is filled with waste up to a level touched by the vessel guarding edge 12, indicating that the container is full and needs to be replaced. The container can be detached from the seat and emptied completely by moving the retaining rods 18 (FIG. 5).

The configuration of the solid container provides optimal conditions for aerobic decomposition of human waste without physically mixing the waste inside the container. The container is also expandable, as indicated in 24, as shown in FIG. 6 and adaptable to different physical space and needs.

### Embodiment 2

### Compositing Toilet with a Stacking Configuration

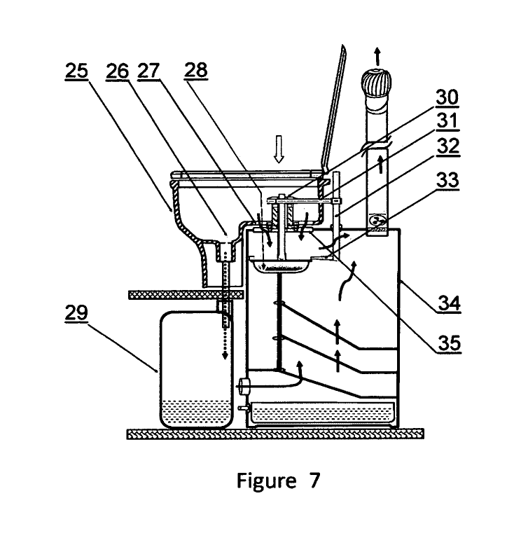

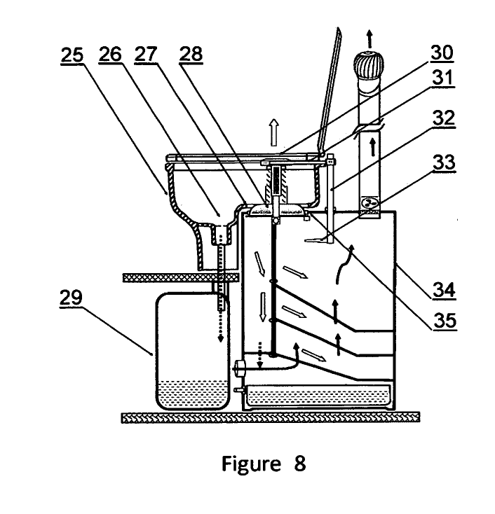

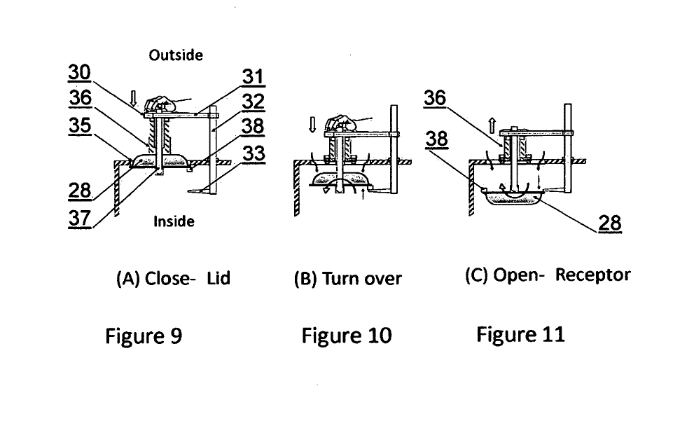

The major difference of this embodiment of the invention is in the seat-container arrangement and the solid waste delivery comparing to Embodiment 1. As illustrated in FIGS. 7 and 8, the toilet has the same set of components, a seat 25, a solid waste vessel 28, a liquid container 29 and a solid container 34, but with the seat 25 sits partially on the top of the solid container 34 with their openings 27 and 35 facing each other directly. To accommodate the solid container 34 the opening 27 of the seat bowl is usually at a raised level. The waste vessel is located inside the solid container. When the toilet is not in use, the vessel closes the container with its convex surface facing up against the inner side of the opening 35 by a pulling force from a spring 36 at the top of the container. When it is moved down by hand on the pushing handle 30, the vessel 28 flips over with the concave surface facing up towards the large seat opening 27, and now serves as the waste receptor ready to receive peat moss and solid human waste as shown in FIG. 7. At the same time an electrical fan installed inside the container is switched on and creates a negative pressure inside the space connecting the container and the seat. When it is pulled up by the spring force, the vessel then flips down and drops the waste within the container before it closes the container with its convex surface (FIG. 8). The mechanism controlling the vessel transfer is illustrated in FIGS. 9-11 in detail.

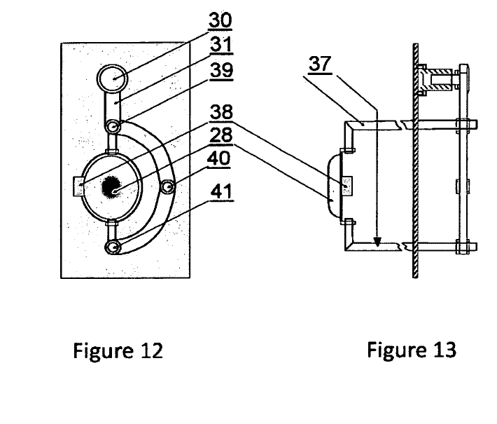

The conversion of the vessel between the waste receptor and the container lid is performed with an assembly consisting of 1) a trip lever 31 with a pushing handle 30 and three holes on it: 39, 40 and 41, 2) a spring case 36 under the pushing handle, 3) a guidance pole 32 on the top of the container with an extension inside the container, 4) a stopper 33 attached to the pole extension, and 5) two linking rods 37 connecting the vessel and the trip lever across the top of the container. The trip lever is restrained horizontally by the spring case 36 and the guidance pole 32 through the hole 40. The linking rods connect the trip lever through two holes 39 and 41. There is a weight balancer 38 attached to the edge of the vessel, between the two mounting points to the linking rods (FIGS. 12 and 13). When the trip lever moves down, the vessel meets the stopper and is forced to rotate counterclockwise (FIGS. 9 and 10). After the vessel turns 180° with its concave surface facing up, the stopper blocks it from further rotation. Balanced by both the stopper and the weight balancer the vessel is stabilized and is now ready to serve as the waste receptor after it is locked, as shown in FIG. 11. After the pushing handle 30 is released, the trip lever 31 is pulled up by the string force and the vessel is pushed downwards by the stopper and rotates clockwise. After it turns over, the vessel continues on moving up and stops by the rim of the container opening 35 and closes up the container. It may be necessary to clean the vessel with water; the cleaning water will stay in the open liquid pan 22 at the bottom of the solid container, but will not flood the container with the overflowing outlet 21.

When it is time to replace the solid container, the vessel transfer assembly can be removed as a unit and replaced by a cover board or a substitute lid before transportation and dumping, avoiding damage of the equipment.

The above mentioned exemplifying embodiments are provided to serve the purpose of clarifying the aspects of the invention, do not serve to limit the scope of the invention. All modifications and improvements have been deleted herein for the sake of conciseness and readability but are properly within the scope of the present invention and the claims. The invention can be varied within the claims described herein.

1. A waterless composting toilet comprising:
a) a seat having a bowl with a liquid outlet in the front and a large opening in the back either at the bottom or the side wall, a seat ring attached to the bowl and a seat cover attached to the seat ring;
b) a liquid container collecting urine or cleaning water;
c) a solid waste transfer vessel that has a concave surface in its center and extensions in the edge designed to connect a mechanical controlling assembly;
d) a solid waste container having a liquid pan at the bottom, two openings: an air inlet close to its bottom and a waste access at the top or the side wall, and a set of thin porous plates or screens installed on a set of movable retaining rods in an angle relative to the bottom of the container and separated by a distance;
e) a venting system on the top of the container body, consisting of a venting pipe, a natural power exhaust fan at the top end of the pipe and an electrical fan in the bottom end of the pipe, or optionally inside the container with the air expelled into the venting pipe.

2. A composting toilet as claimed in claim 1, characterized in that the said seat and solid container are arranged side by side with their openings facing each other directly and that the waste vessel transfers between the seat and the solid container by a rotating crank located between the seat and the solid container.

3. A composting toilet as claimed in claim 1, characterized in that the seat bowl opens on the bottom and stacks on the top of the solid container and that the waste vessel locates inside the solid container and serves as either a waste receptor or a solid container lid, and the functional conversion is carried out through a mechanical assembly consisting of: a trip lever attached with a handle and a spring under the handle, a guidance pole with a stopper in its extension inside the solid container, two linking rods connecting the trip lever and the vessel across the top of the container, and a weight balancer attached to the vessel on its edge.

4. The said waste vessel in claims 2 and 3 is supplied with a bed of peat moss or sawdust prior to use as a solid waste receptor.

5. Moving of the said waste vessel in claims 2 and 3 away from the solid container turns on the electrical fan in the venting system to draw the air away from the seat bowl and the waste container.
